(19) United States
(12) Patent Application Publication
(10) Pub. No.: US 2015/0145827 A1
(43) Pub. Date: May 28, 2015

(54) Operation Display Device That Ensures Operation without Touching Display Unit

(71) Applicant: Kyocera Document Solutions Inc., Osaka (JP)

(72) Inventor: Koji Maeda, Osaka (JP)

(21) Appl. No.: 14/555,504

(22) Filed: Nov. 26, 2014

(30) Foreign Application Priority Data
Nov. 26, 2013 (JP) 2013-243916

(51) Int. Cl. G06F 3/041; H04N 1/00; G06F 3/0484; G06F 3/0488; G06F 3/044; G06F 3/0482

(52) U.S. Cl. CPC G06F 3/0418; G06F 3/044; G06F 3/0482; G06F 3/04842; G06F 3/04886; H04N 1/00392; H04N 1/00411; H04N 1/00413; H04N 1/00474; H04N 2201/0094
USPC 345/174; 345/178

(57) ABSTRACT

An operation display device includes a display unit, a display control unit, a coordinate measuring unit, an overlap determining unit, and a first operation accepting unit. The coordinate measuring unit measures a coordinate of a first direction, a coordinate of a second direction, and a coordinate of a third direction indicative of a position of an object. The overlap determining unit determines whether the object within the predetermined distance from a first screen overlaps a software key or not. The first operation accepting unit accepts an operation of the software key when the first operation accepting unit determines that the coordinate of the third direction has changed. When the first operation accepting unit accepts the operation of the software key, the display control unit switches the screen displayed by the display unit from the first screen to a second screen.

### INCORPORATION BY REFERENCE

This application is based upon, and claims the benefit of priority from, corresponding Japanese Patent Application No. 2013-243916 filed in the Japan Patent Office on Nov. 26, 2013, the entire contents of which are incorporated herein by reference.

### BACKGROUND

Unless otherwise indicated herein, the description in this section is not prior art to the claims in this application and is not admitted to be prior art by inclusion in this section.

As an operation display device, a touch panel apparatus is widely used. The touch panel apparatus is operated by touching a display unit on which a screen is displayed with an object such as a fingertip and a dedicated pen.

The following touch panel apparatus has been proposed. When the touch panel apparatus detects that an object approaches the display unit, the touch panel apparatus performs a predetermined process before the object touches the display unit. For example, to prevent pushing a wrong icon, there has been proposed the following technique. When a distance between a finger and the display unit becomes equal to or less than a predetermined distance, this technique specifies the icon approached by the finger and enlarges the icon.

Additionally, as an apparatus that performs a predetermined process without in contact with an object, the following vehicle door opening/closing apparatus has been proposed. The vehicle door opening/closing apparatus detects a movement of a human body present in a predetermined range without in contact with the human body with a sensor arranged at an outer surface of a vehicle to open and close a vehicle door.

### SUMMARY

An operation display device according to one aspect of the disclosure includes a display unit, a display control unit, a coordinate measuring unit, an overlap determining unit, and a first operation accepting unit. The display control unit causes the display unit to display a screen. The coordinate measuring unit measures a coordinate of a first direction, a coordinate of a second direction, and a coordinate of a third direction indicative of a position of an object corresponding to a position of the object within a predetermined distance from the screen. The first direction and the second direction are directions to specify a plane of coordinates on the screen. The third direction is a direction vertical to the screen. The overlap determining unit determines whether the object within the predetermined distance from a first screen overlaps a software key viewed from the third direction or not using the coordinate of the first direction, the coordinate of the second direction, and the coordinate of the third direction in a state where the first screen is displayed on the display unit. The first screen is the screen including the software key. The first operation accepting unit accepts an operation of the software key when the first operation accepting unit determines that the coordinate of the third direction has changed in a state where the overlap determining unit determines that the object overlaps the software key. When the first operation accepting unit accepts the operation of the software key, the display control unit switches the screen displayed by the display unit from the first screen to a second screen. The second screen is the screen different from the first screen.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 schematically illustrates an internal structure of an image forming apparatus that includes an operation display device of the disclosure.

FIG. 2 illustrates the configuration of the image forming apparatus according to one embodiment.

FIG. 3 illustrates the configuration of the operation display device according to the first embodiment.

FIG. 4 illustrates a side of a display unit included in the operation display device according to the first embodiment.

FIGS. 5A and 5B illustrate the state where each of the first ranging sensor, the second ranging sensor, the third ranging sensor, and the fourth ranging sensor measures the distance to the object which is above a panel surface.

FIG. 6 illustrates a quadrangular pyramid which has the vertices of the object position, the position of the first ranging sensor, the position of the second ranging sensor, the position of the third ranging sensor, and the position of the fourth ranging sensor.

FIG. 7 illustrates a quadrangular pyramid Q according to the first embodiment in a development view.

FIG. 8 illustrates a triangle I cut out from the development view of the quadrangular pyramid Q.

FIG. 9 illustrates a triangle II cut out from the development view of the quadrangular pyramid Q.

FIG. 10 illustrates a cubic diagram of a quadrangular pyramid q. The quadrangular pyramid q is a quadrangular pyramid that is cut out from the quadrangular pyramid Q along the direction parallel to the y-axis and passing through an object position P, and along the direction parallel to the x-axis and passing through the object position P.

FIG. 11 illustrates a screen for selecting functions in the copy mode.

FIG. 12 illustrates a screen for setting the number of pages of the original document aggregated in one sheet at the setting of the multiple per sheet print in the touch operation mode.

FIG. 13 illustrates a screen for setting the direction of the original document at the setting of the multiple per sheet print in the touch operation mode.

FIG. 14 illustrates a screen for setting the number of pages of the original document to aggregate in one sheet at the setting of the multiple per sheet print in the non-touch operation mode.

FIG. 15 illustrates a screen for setting the direction to set the original document at the setting of the multiple per sheet print in the non-touch operation mode.

FIG. 16 illustrates the configuration of the operation display device according to the second embodiment.

FIG. 17 illustrates a screen for setting the enlargement/reduction of the copying image in the non-touch operation mode.

FIG. 18 illustrates a screen for setting the enlargement/reduction of the copying image in the touch operation mode.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

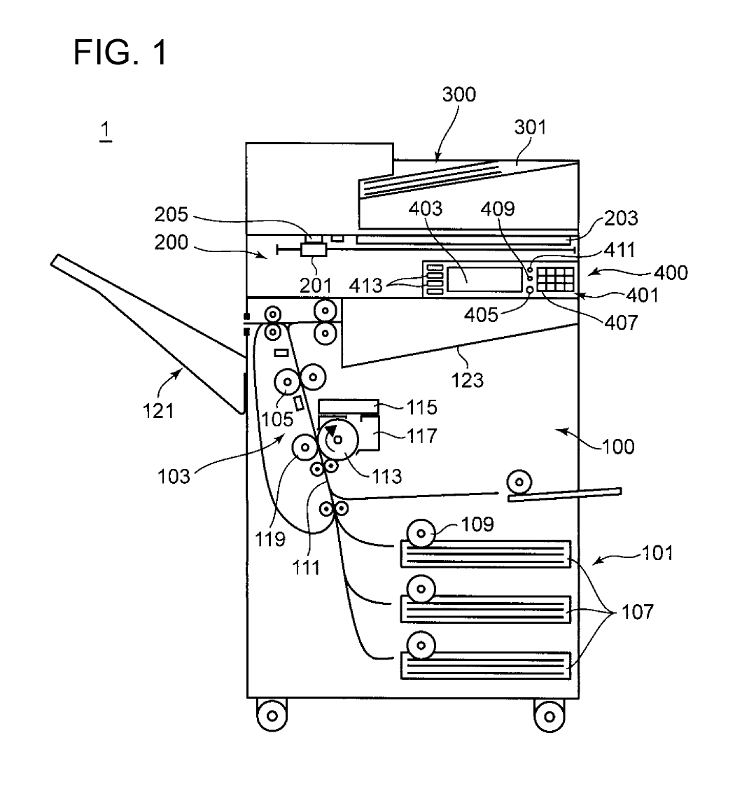

The following describes embodiments of the disclosure in detail based on the drawings. FIG. 1 schematically illustrates an internal structure of an image forming apparatus 1 that includes an operation display device according to the embodiment. The image forming apparatus 1 can be applied to digital multi-functional peripherals that have the function of copying, printer, scanner, facsimile, and similar function. The image forming apparatus 1 includes an apparatus main body 100, a document reading unit 200, which is arranged on the apparatus main body 100, a document feeding unit 300, which is arranged on the document reading unit 200, and an operation unit 400, which is arranged upper front face of the apparatus main body 100.

The document feeding unit 300 functions as an automatic document feed apparatus. The document feeding unit 300 can feed a plurality of original document sheets put on a document platen 301 to the document reading unit 200 to read out continuously.

The document reading unit 200 includes a carriage 201 that mounts such as an exposing lamp, a platen 203 constituted of a transparent member such as glass, not illustrated Charge Coupled Device (CCD) sensor, and a document reading slit 205. To read documents placed on the platen 203, the carriage 201 moves in the longitudinal direction of the platen 203. Then, the CCD sensor reads the document. In contrast to this, to read documents conveyed by the document feeding unit 300, the carriage 201 moves to the position facing the document reading slit 205. Then, the CCD sensor reads the document conveyed by the document feeding unit 300 via the document reading slit 205. The CCD sensor obtains image data read from the document, and outputs the image data.

The apparatus main body 100 includes a paper sheet storage unit 101, an image forming unit 103, and a fixing unit 105. The paper sheet storage unit 101 is arranged in the lowest portion inside the apparatus main body 100. The paper sheet storage unit 101 includes a paper sheet tray 107, which can store the bundle of papers. The top paper sheet of the bundle of papers stored in the paper sheet tray 107 is delivered toward a paper sheet conveyance passage 111 by driving of a pickup roller 109. The paper sheet is conveyed to the image forming unit 103 via the paper sheet conveyance passage 111.

The image forming unit 103 forms a toner image on the fed paper sheet. The image forming unit 103 includes a photoreceptor drum 113, an exposure unit 115, a developing unit 117, and a transfer unit 119. The exposure unit 115 generates a modulated light corresponding to the image data (such as image data output from the document reading unit 200, image data transmit from the PC, and facsimile reception image data), irradiates the uniformly charged circumference surface of the photoreceptor drum 113 with the light. This forms an electrostatic latent image, which corresponds to the image data, on the circumference surface of the photoreceptor drum 113. In this state, the toner image corresponding to the image data is formed on the circumference surface of the photoreceptor drum 113 by supplying toner from the developing unit 117. This toner image is transferred to the paper sheet, which is fed from the above-described paper sheet storage unit 101, by the transfer unit 119.

The paper sheet on which the toner image is transferred is transmitted to the fixing unit 105. In the fixing unit 105, heat and pressure is applied to the toner image and the paper sheet, and the toner image is fixed on the paper sheet. The paper sheet is discharged to a stack tray 121 or a sheet discharge tray 123.

The operation unit 400 includes an operation key portion 401 and a display unit 403. The display unit 403 has a touch panel function and displays the screen including such as software keys. The user configures settings required to execute, for example, a copying function by operating such as software keys while watching the screen.

The operation key portion 401 includes operation keys constituted of hardware keys. Specifically, the operation key portion 401 includes such as a start key 405, a numeric keypad 407, a stop key 409, a reset key 411, and a function switching key 413, which switches copying, printer, scanner, and facsimile.

The start key 405 is a key that starts operations such as copying and facsimile transmission. The numeric keypad 407 is a key that receives numerals such as the number of copies or facsimile numbers. The stop key 409 is a key that aborts operations such as copying in its course. The reset key 411 is a key that resets a set content to the initial setting.

The function switching key 413 includes a copying key, a transmission key, and a similar key, and switches mutually between, for example, copying function and transmitting function. Operating the copying key displays the initial screen of copying on the display unit 403. Operating the transmission key displays the initial screen of facsimile transmission and e-mail transmission on the display unit 403.

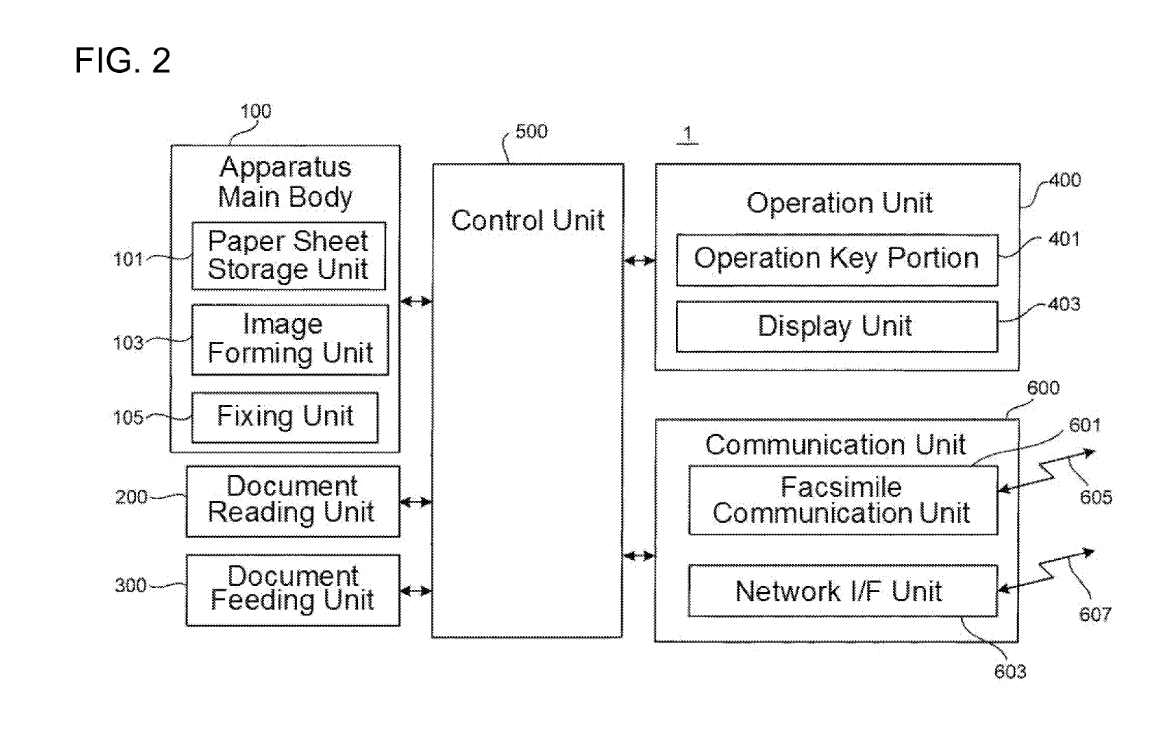

FIG. 2 illustrates a configuration of the image forming apparatus 1 illustrated in FIG. 1. The image forming apparatus 1 has a constitution where the apparatus main body 100, the document reading unit 200, the document feeding unit 300, the operation unit 400, a control unit 500, and a communication unit 600 are mutually connected with a bus. The description of the apparatus main body 100, the document reading unit 200, the document feeding unit 300, and the operation unit 400 will be omitted because previously described.

The control unit 500 includes such as, Central Processing Unit (CPU), Read Only Memory (ROM), Random Access Memory (RAM), and an image memory. The CPU executes a control required to perform the image forming apparatus 1 with respect to the above-described components, such as the apparatus main body 100, within the image forming apparatus 1. The ROM stores software required to control the performance of the image forming apparatus 1. The RAM is a memory that temporarily stores data generated during execution of the software, and stores the application program and similar data. The image memory temporarily stores image data (such as image data output from the document reading unit 200, image data transmit from the PC, and facsimile reception image data).

The communication unit 600 includes a facsimile communication unit 601 and a network I/F unit 603. The facsimile communication unit 601 includes Network Control Unit (NCU), which controls the telephone line connection with the other side of the facsimile and a modulation and demodulation circuit, which modulates and demodulates the signal for the facsimile communication. The facsimile communication unit 601 is connected to a telephone line 605.

The network I/F unit 603 is connected to a Local Area Network (LAN) 607. The network I/F unit 603 is a communication interface circuit, which executes communication with the terminal device such as the PC connected to the LAN 607.

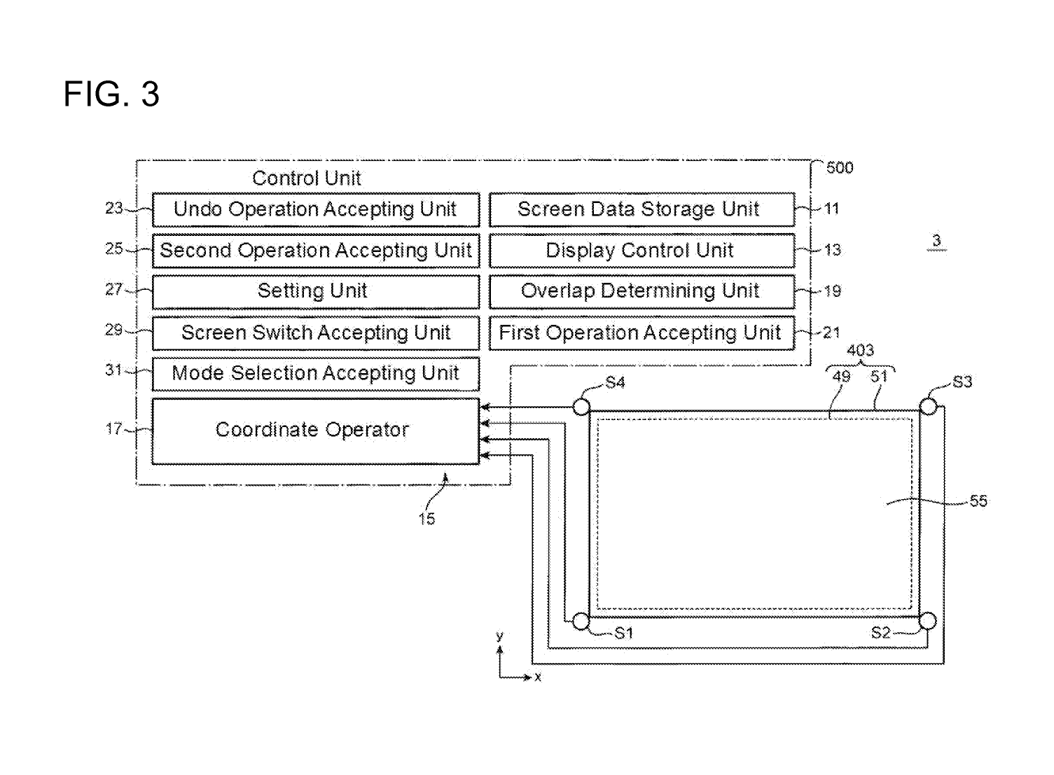

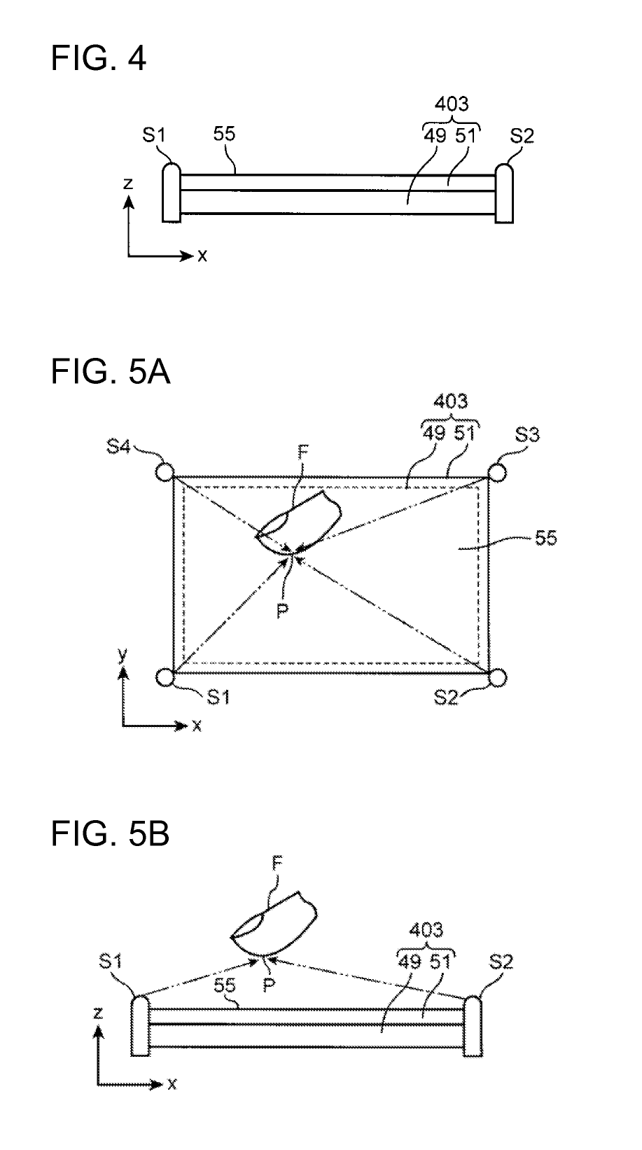

The embodiments include the first embodiment and the second embodiment. The first embodiment will be described. FIG. 3 illustrates a configuration of an operation display device 3 according to the first embodiment. The operation display device 3 includes the display unit 403, first to fourth ranging sensors S1 to S4, a screen data storage unit 11, a display control unit 13, a coordinate operator 17, an overlap determining unit 19, a first operation accepting unit 21, an undo operation accepting unit 23, a second operation accepting unit 25, a setting unit 27, a screen switch accepting unit 29, and a mode selection accepting unit 31. The display unit 403 is illustrated in a plan view. FIG. 4 illustrates the side view of the display unit 403.

The control unit 500 includes the screen data storage unit 11, the display control unit 13, the coordinate operator 17, the overlap determining unit 19, the first operation accepting unit 21, the undo operation accepting unit 23, the second operation accepting unit 25, the setting unit 27, the screen switch accepting unit 29, and the mode selection accepting unit 31. These are described as function blocks.

The display unit 403 includes a display panel portion 49 and a touch panel portion 51, which is arranged on the display panel portion 49.

The touch panel portion 51 is a unit that includes a panel surface 55 to be touched by an object such as a fingertip, and the touch panel portion 51 detects the position where the panel surface 55 is touched. The object that touches the panel surface 55 is, for example, a fingertip and the dedicated pen. The method of the touch panel portion 51 includes various kinds of methods such as a resistance film system and an electrostatic capacity method.

The display panel portion 49 displays the screen. The screen displayed on the display unit 403 is the screen that is displayed on the display panel portion 49 via the touch panel portion 51. The display panel portion 49 is ensured by a liquid crystal display panel or similar panel.

Directions that specify a plane of coordinates on the screen displayed on the display unit 403 are defined as a first direction and a second direction, and the direction that is vertical to the screen is defined as a third direction. This embodiment will be described assuming that the first direction, the second direction, and the third direction are respectively the x-axis direction, the y-axis direction, and the z-axis direction.

The display unit 403 has four corners at which the first to fourth ranging sensors S1, S2, S3, and S4 are arranged. The first to fourth ranging sensors 51, S2, S3, and S4 constitute a coordinate measuring unit 15, which will be described later.

The screen data storage unit 11 preliminarily stores screen data indicative of a screen to be displayed on the display unit 403.

The display control unit 13 reads out the above-described screen data from the screen data storage unit 11, and controls to display the screen on the display unit 403. One example of the screen will be described. FIG. 11 describes a screen 61 for selecting functions in the copy mode. The screen 61 includes a paper sheet setting key 62, an enlargement/reduction key 63, a copy density key 64, a staple key 65, and, an aggregate key 66. These keys are software keys.

The paper sheet setting key 62 is a key that switches the screen 61 displayed on the display unit 403 to a screen for setting the size of a copy paper. The enlargement/reduction key 63 is a key that switches the screen displayed on the display unit 403 to a screen for setting the enlargement/reduction of the copying image. The copy density key 64 is a key that switches the screen 61 displayed on the display unit 403 to a screen for setting the print density of the copying image. The staple key 65 is a key that switches the screen 61 displayed on the display unit 403 to a screen for setting the staple. The aggregate key 66 is a key that switches the screen 61 displayed on the display unit 403 to a screen for setting the multiple per sheet print.

Returning to the description of FIG. 3, the coordinate operator 17 and the first to fourth ranging sensors S1, S2, S3, and S4 constitute the coordinate measuring unit 15.

The coordinate measuring unit 15 measures the position of the object such as a fingertip above the panel surface 55 when the distance between the object and the panel surface 55 is equal to or less than a predetermined value corresponding to a change of the object position. The coordinate measuring unit 15 measures the position of the object by measuring x coordinate, y coordinate, and z coordinate indicating the position of the object. That is, the coordinate measuring unit 15 measures the x coordinate, the y coordinate and the z coordinate indicating the position of the object, corresponding to the change of the object position within the predetermined distance from the screen displayed on the display unit 403.

FIGS. 5A and 5B illustrate a state where the distance to an object F above the panel surface 55 is measured by each of the first ranging sensor S1, the second ranging sensor S2, the third ranging sensor S3, and the fourth ranging sensor S4. FIG. 5A indicates the object F viewed from above the display unit 403, and FIG. 5B indicates the object F viewed from the side of the display unit 403. The object F is a fingertip. The method of measuring the x coordinate, the y coordinate, and the z coordinate indicating an object position P as the position of the object F, will be described later.

With reference to FIG. 3 and FIGS. 5A and 5B, the overlap determining unit 19 determines whether or not the object F, which is within the predetermined distance from the screen, overlaps with a software key by using x coordinate, y coordinate, and z coordinate of the object position P when viewing in the z-axis direction (the direction normal to the screen), in a state where the screen (a first screen) including software keys is displayed on the display unit 403. The software keys mean, for example, various keys 62 to 66 included in the screen 61 as shown in FIG. 11.

When the x coordinate of the object position P is included in a range of the x coordinate of the software key, the y coordinate of the object position P is included in a range of the y coordinate of the software key, and the z coordinate of the object position P is not included in a range of the z coordinate of the software key, the object F can be determined to be overlapping with the software key when viewing in the z-axis direction.

The state where the object F overlaps with the software key when viewing in the z-axis direction is, in other words, the state where the object F three-dimensionally overlaps with the software key, or the state where the object F is positioned above the software key.

In a state where the object F is determined to be overlapping with the software key by the overlap determining unit 19, the first operation accepting unit 21 accepts the operation of the software key when the coordinate measuring unit 15 determines the z coordinate of the object position P to be changed. When the first operation accepting unit 21 accepts the operation of the software key, the display control unit 13 causes the display unit 403 to switch the screen to be displayed (switching from the first screen to the second screen, which is different from the first screen).

The first operation accepting unit 21 has a first aspect and a second aspect as the aspect for accepting the operation of the software key. The first aspect is an aspect that accepts the operation of the software key when the object F approaches the software key, in a state where the object F illustrated in FIGS. 5A and 5B, which is within the predetermined distance from the screen, overlaps with the software key when viewing in the z-axis direction. The second aspect is an aspect that accepts the operation of the software key when the object F is brought away from the software key, in a state where the object F, which is within the predetermined distance from the screen, overlaps with the software key when viewing in the z-axis direction.

In this embodiment, a description will be given of the first aspect. Therefore, in a state where the overlap determining unit 19 determines that the object F overlaps with the software key, the first operation accepting unit 21 determines whether or not the object F approaches the software key by using the change of z coordinate of the object position P, and when the first operation accepting unit 21 determines the object F to approach the software key, the first operation accepting unit 21 accepts the operation of the software key.

Assume that after the screen (the second screen) is switched, the overlap determining unit 19 uses the x coordinate, y coordinate, and z coordinate of the object position P, which is measured by the coordinate measuring unit 15, to determine that the object F, which is within the predetermined distance from the screen (the second screen), overlaps with the position where the software key is displayed on the screen (the first screen) when viewing in the z-axis direction, and the object F is brought away from the screen (the second screen). In this case, the undo operation accepting unit 23 accepts the operation to return to the previous screen. When the undo operation accepting unit 23 accepts the operation to return to the previous screen, the display control unit 13 causes the display unit 403 to switch the screen to be displayed (switching from the second screen to the first screen).

In a state where the screen (the first screen) including the software keys is displayed on the display unit 403 (the display panel portion 49), the second operation accepting unit 25 accepts the operation of the software key when the object F touches the panel surface 55 at the software key.

When the first operation accepting unit 21 and the second operation accepting unit 25 accept any of the operation among the plurality of the software keys, the setting unit 27 accepts the setting assigned to the software key on which the operation is accepted.

In a state where the overlap determining unit 19 determines that the object F does not overlap with any of the plurality of the software key, the screen switch accepting unit 29 accepts switching of the screens when the z coordinate of the object position P is determined to be changed.

The mode selection accepting unit 31 accepts selection of the touch operation mode when the user selects the touch operation mode by operating the operation unit 400 (see FIG. 2), and accepts selection of the non-touch operation mode when the user selects the non-touch operation mode by operating the operation unit 400.

The touch operation mode is a mode that executes operations such as acceptance of the operation of the software key and switching the screen that is displayed on the display unit 403, using the display panel portion 49, the touch panel portion 51, the display control unit 13, the second operation accepting unit 25, and the setting unit 27. The touch operation mode is an operation mode that is similar to an ordinary touch panel apparatus, and a mode that is operated by touching the panel surface 55.

The non-touch operation mode is a mode that executes operations such as acceptance of the operation of the software key and switching the screen that is displayed on the display unit 403, using the display panel portion 49, the display control unit 13, the coordinate measuring unit 15, the overlap determining unit 19, the first operation accepting unit 21, the undo operation accepting unit 23, the setting unit 27, and the screen switch accepting unit 29. The non-touch operation mode is the mode that is operated without touching the panel surface 55.

The method of measuring the x coordinate, the y coordinate, and the z coordinate indicative of the object position P as the position of the object F will be described in detail.

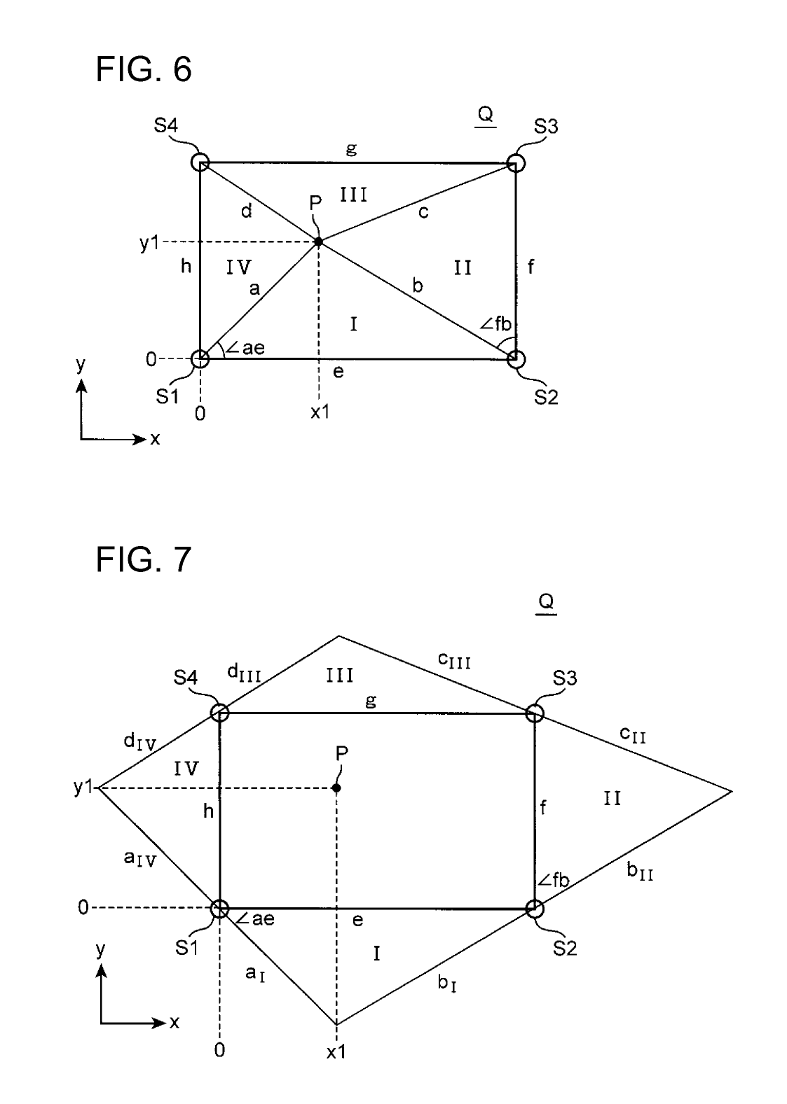

FIG. 6 illustrates a quadrangular pyramid Q having vertices of the object position P, the position of the first ranging sensor S1, the position of the second ranging sensor S2, the position of the third ranging sensor S3, and the position of the fourth ranging sensor S4. The position of the first ranging sensor S1 is assumed as an origin.

The first ranging sensor S1 and the second ranging sensor S2 have the same value of the y coordinate (=0), and the third ranging sensor S3 and the fourth ranging sensor S4 have the same value of the y coordinate. The first ranging sensor S1 and the fourth ranging sensor S4 have the same value of the x coordinate (=0) second ranging sensor S2 and the third ranging sensor S3 have the same value of the x coordinate. The x coordinate of the object position P is assumed as x1, and the y coordinate of the object position P is assumed as y1.

The distance from the position of the first ranging sensor S1 to the object position P, which is measured by using the first ranging sensor S1, is indicated as a side a. The distance from the position of the second ranging sensor S2 to the object position P, which is measured by using the second ranging sensor S2, is indicated as a side b. The distance from the position of the third ranging sensor S3 to the object position P, which is measured by using the third ranging sensor S3, is indicated as a side c. The distance from the position of the fourth ranging sensor S4 to the object position P, which is measured by using the fourth ranging sensor S4, is indicated as a side d.

The four triangular side surfaces of the quadrangular pyramid Q are indicated as the triangle I, the triangle II, a triangle III, and a triangle IV. The triangle I is a triangle that has the vertices of the object position P, the position of the first ranging sensor S1, and the position of the second the ranging sensor S2. The triangle I has three sides of the side a, the side b, and a side e, which connects the position of the first ranging sensor S1 and the position of the second ranging sensor S2. The corner that is specified by the side a and the side e is indicated as the corner ∠ae.

The triangle II is a triangle that has vertices of the object position P, the position of the second ranging sensor S2, and the position of the third the ranging sensor S3. The triangle II has three sides of the side b, the side c, and a side f, which connects the position of the second ranging sensor S2 and the position of the third ranging sensor S3. The corner that is specified by the side b and the side f is indicated as the corner ∠fb.

The triangle III is a triangle that has vertices of the object position P, the position of the third ranging sensor S3, and the position of the fourth ranging sensor S4. The triangle III has three sides of the side c, the side d, and a side g, which connects the position of the third ranging sensor S3 and the position of the fourth ranging sensor S4.

The triangle IV is a triangle that has vertices of the object position P, the position of the fourth ranging sensor S4, and the position of the first ranging sensor S1. The triangle IV has three sides of the side d, the side a, and a side h, which connects the position of the fourth ranging sensor S4 and the position of the first ranging sensor S1 .

FIG. 7 illustrates the quadrangular pyramid Q in a development view. The triangle I has the side a indicated as the side a_{I}, and the side b indicated as the side b_{I}. The triangle II has the side b indicated as the side b_{II}, and the side c indicated as the side c_{II}. The triangle III has the side c indicated as the side c_{III}, and the side d is indicated as the side d_{III}. The triangle IV has the side d of the indicated as the side d_{IV}, and the side a indicated as the side a_{IV}.

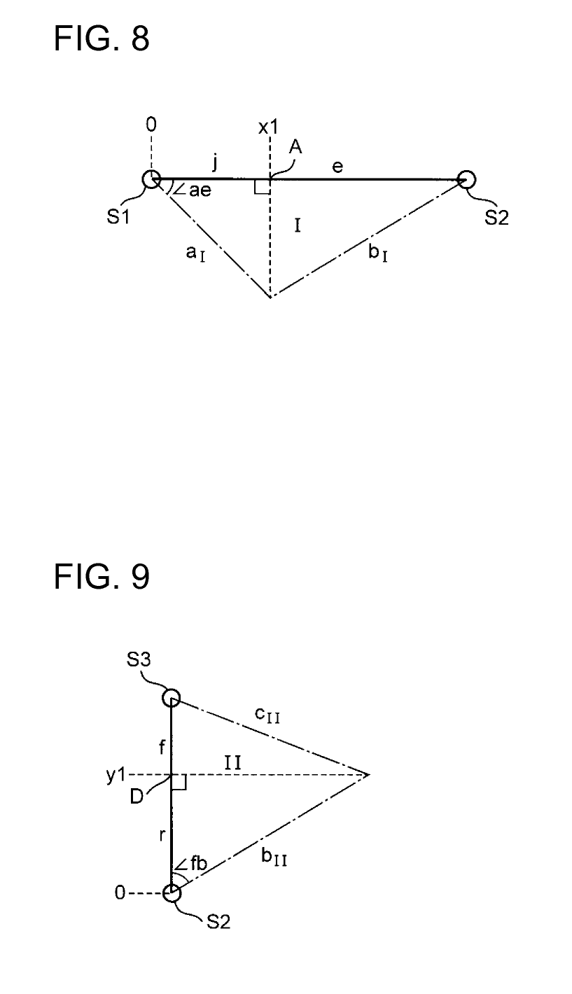

FIG. 8 illustrates the triangle I cut out from the development view illustrated in FIG. 7. The position where the x coordinate is x1 on the side e is defined as a position A. The side that connects the position of the first ranging sensor S1 and the position A is defined as a side j.

According to the law of cosines, cos ∠ae=(a_{I}²+e²−b_{I}²)/(2×a_{I}×e). Cos ∠ae=j/a_{I}, then, j=a_{I}×cos ∠ae. The length of the side j, in other words, x1 as the value of the x coordinate of the object position P, is a_{I}×cos ∠ae.

FIG. 9 illustrates the triangle II cut out from the development view illustrated in FIG. 7. The position where the y coordinate is y1 on the side f is defined as a position D. The side that connects the position of the second ranging sensor S2 and the position D is defined as a side r.

According to the law of cosines, cos ∠fb=(b_{II}²+f²−c_{II}²)/(2×b_{II}×f). Thus, cos ∠fb=r/b_{II}, then, r=b_{II}×cos ∠fb. The length of the side r, in other words, y1 as the value of the y coordinate of the object position P, is b_{II}×cos ∠fb.

The triangle II is used to obtain y1, which is the y coordinate of the object position P. However, use of the formula of sin² θ+cos² θ=1 obtains sin ∠ herefore, use of the triangle I illustrated in FIG. 6 also obtains the y coordinate y1 of the object position P. Then, use of the triangle I can obtain the x coordinate and the y coordinate of the object position P. Use of the triangle II can obtain the x coordinate and the y coordinate of the object position P. Use of the triangle III can obtain the x coordinate and the y coordinate of the object position P. Use of the triangle IV can obtain the x coordinate and the y coordinate of the object position P.

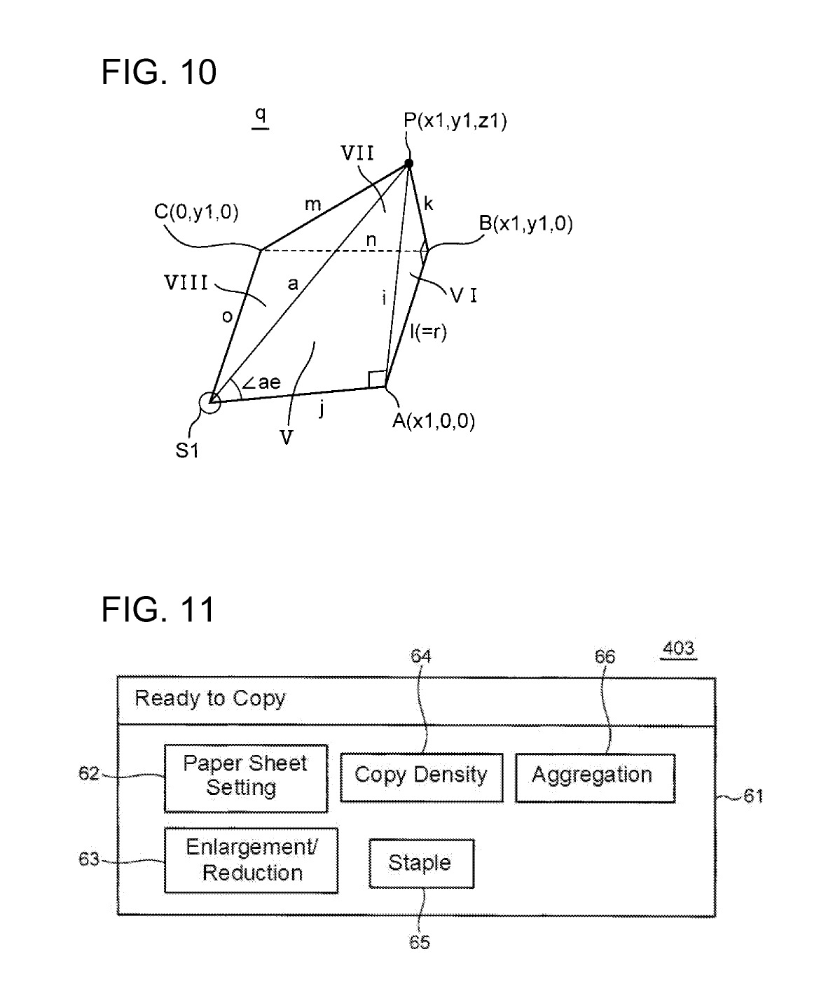

The method of obtaining the z coordinate z1 of the object position P will be described. FIG. 10 illustrates a cubic diagram of a quadrangular pyramid q. The quadrangular pyramid q is a quadrangular pyramid that is cut out from the quadrangular pyramid Q, which is illustrated in FIG. 6, along the direction parallel to the y-axis and passing through the object position P, and along the direction parallel to the x-axis and passing through the object position P. The object position P has the coordinate of (x1, y1, z1).

The quadrangular pyramid q includes four triangular shape side surfaces of a triangle V, a triangle VI, a triangle VII, and a triangle VIII. The triangle V is a triangle that has vertices of the object position P, the position of the first ranging sensor S1, and the position A. The triangle V is a part of the triangle I illustrated in FIG. 6. The position A has the coordinate of (x1, 0, 0). The triangle V has the three sides of the side a, the side j, and a side i, which connects the object position P and the position A.

The triangle VI is a triangle that has vertices of the object position P, the position A, and a position B. The position B has the coordinate of (x1, y1, 0). The triangle VI has the three sides of the side i, a side I, and a side k, which connects the object position P and the position B.

The triangle VII is a triangle that has the vertices of the object position P, the position B, and a position C. The position C is on the side h illustrated in FIG. 6. The position C has the coordinate of (0, y1, 0). The triangle VII has the three sides of the side k, a side m, which connects the object position P and the position C, and a side n, which connects the position B and the position C.

The triangle VIII is a triangle that has the vertices of the object position P, the position C, and the position of the first ranging sensor Si. The triangle VIII is a part of the triangle IV illustrated in FIG. 6. The triangle VIII has the three sides of the side m, the side a, and the side o which connects the position C and the position of the first ranging sensor S1.

Here, tan ∠ae=i/j, then, i=j×tan ∠ae. Then, use of the Pythagorean theorem (i²=l²+k²)obtains the length of the side k, that is, the z coordinate z1of the object position P.

As described above, the first to fourth ranging sensors S1, S2, S3, and S4, which are illustrated in FIG. 5A, are used to measure the respective distances to the object F for determining each of the x coordinate, the y coordinate, and the z coordinate of the object position P. This ensures the measurement of the object position P.

The coordinate operator 17 illustrated in FIG. 3 preliminarily stores the formula to obtain the x coordinate x1 and the y coordinate y1 of the object position P using the triangle I. The coordinate operator 17 uses the formula, the distance to the object F (=the side a), which is measured by the first ranging sensor S1, and the distance to the object F (=the side b), which is measured by the second ranging sensor S2, to operate the x coordinate x1 and the y coordinate y1 of the object position P.

The coordinate operator 17 preliminarily stores the formula to obtain the x coordinate x1 and the y coordinate y1 of the object position P using the triangle II. The coordinate operator 17 uses the formula, the distance to the object F (=the side b), which is measured by the second ranging sensor S2, and the distance to the object F (=the side c), which is measured by the third ranging sensor S3, to operate the x coordinate x1 and the y coordinate y1 of the object position P.

The coordinate operator 17 preliminarily stores the formula to obtain the x coordinate x1 and the y coordinate y1 of the object position P using the triangle III. The coordinate operator 17 uses the formula, the distance to the object F (=the side c), which is measured by the third ranging sensor S3, and the distance to the object F (=the side d), which is measured by the fourth ranging sensor S4, to operate the x coordinate x1 and the y coordinate y1 of the object position P.

The coordinate operator 17 preliminarily stores the formula to obtain the x coordinate x1 and the y coordinate y1 of the object position P using the triangle IV. The coordinate operator 17 uses the formula, the distance to the object F (=the side d), which is measured by the fourth ranging sensor S4, and the distance to the object F (=the side a), which is measured by the first ranging sensor S1, to operate the x coordinate x1and the y coordinate y1 of the object position P.

As described above, the coordinate operator 17 uses each of the four triangles I, II, Ill, and IV that have the distances (=a, b, c, d), which respectively measured by the first to fourth ranging sensors S1, S2, S3, and S4, as the sides and have the object position P as the vertex, to calculate the x coordinate x1 and the y coordinate y1 of the object position P.

When the condition (matching condition), in which all the x coordinates x1 calculated by using the respective four triangles I, II, Ill, and IV match one another, and all the y coordinates y1 calculated by using the respective four triangles I, II, Ill, and IV match one another, is fulfilled, the object position P is determined at the single point.

The coordinate operator 17 preliminarily stores the formula to obtain the z coordinate z1 of the object position P. When the coordinate operator 17 determines that the matching condition is fulfilled, the coordinate operator 17 uses the formula to obtain the z coordinate z1to calculate the z coordinate z1 of the object position P.

As described above, the coordinate measuring unit 15 measures the x coordinate, y coordinate, and z coordinate of the object position P.

The operation display device 3 according to the first embodiment performs as described below with reference to FIG. 3, FIGS. 5A and 5B, and FIG. 11 to FIG. 15.

The performance of the operation display device 3 includes the touch operation mode and the non-touch operation mode. First, a description will be given of the performance of the touch operation mode in an exemplary setting of the multiple per sheet print.

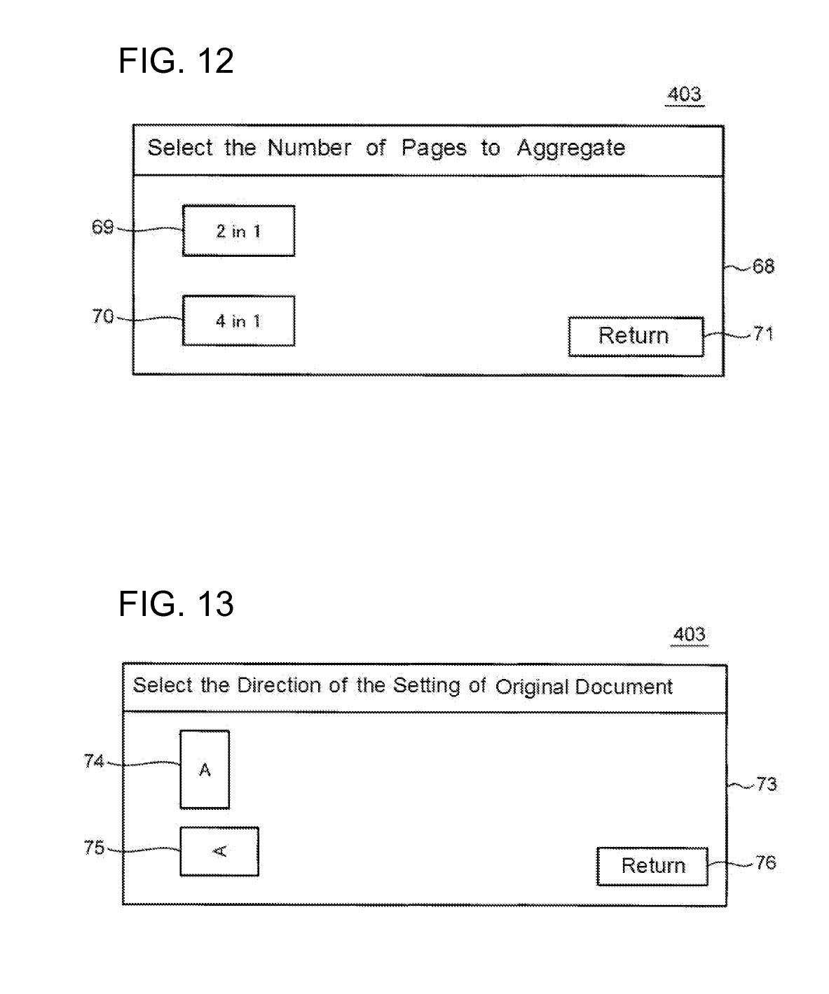

The display control unit 13 controls to display the screen 61 illustrated in FIG. 11 on the display unit 403. As described above, FIG. 11 illustrates the screen 61 for selecting the function in the copy mode. When the panel surface 55 (see FIGS. 5A and 5B), which is above the aggregate key 66 included in the screen 61, is touched by the object F (see FIGS. 5A and 5B), the second operation accepting unit 25 accepts the operation of the aggregate key 66. This causes the display control unit 13 to switch the screen 61 displayed on the display unit 403 to a screen 68 illustrated in FIG. 12

FIG. 12 illustrates the screen 68 for setting the number of pages of the original document aggregated in one sheet at the setting of the multiple per sheet print in the touch operation mode. The screen 68 includes a 2-in-1 key 69, a 4-in-1 key 70, and a return key 71.

The 2-in-1 key 69 is a key for setting the number of pages of the original document aggregated into one sheet to “two pages.” The 4-in-1 key 70 is a key for setting the number of pages of the original document aggregated into one sheet to “four pages.” The return key 71 is a key that returns the screen 68 displayed on the display unit 403 to the previous screen, that is, the screen 61 illustrated in FIG. 11.

When the panel surface 55 (see FIGS. 5A and 5B) above the return key 71 is touched by the object F (see FIG. FIGS. 5A and 5B), the second operation accepting unit 25 accepts the operation of the return key 71. This causes the display control unit 13 to switch the screen 68 displayed on the display unit 403 to the screen 61 illustrated in FIG. 11.

When the panel surface 55 above the 2-in-1 key 69 (or 4-in-1 key 70) is touched by the object F, the second operation accepting unit 25 accepts the operation of the 2-in-1 key 69 (or 4-in-1 key 70). When the operation of the 2-in-1 key 69 is accepted, the setting unit 27 accepts the setting for 2-in-1. When the operation of the 4-in-1 key 70 is accepted, the setting unit 27 accepts the setting for 4-in-1. When the operation of the 2-in-1 key 69 (or 4-in-1 key 70) is accepted, the display control unit 13 switches the screen 68 displayed on the display unit 403 to a screen 73 illustrated in FIG. 13.

FIG. 13 illustrates the screen 73 for setting the direction of the original document at the setting of the multiple per sheet print in the touch operation mode. The screen 73 includes a portrait-oriented key 74, a landscape-oriented key 75, and a return key 76.

The portrait-oriented key 74 is a key for setting the direction of the original document for portrait-oriented. The landscape-oriented key 75 is a key for setting the direction of the original document for landscape-oriented. The return key 76 is a key that returns the screen 73 displayed on the display unit 403 to the previous screen, that is, the screen 68 illustrated in FIG. 12.

When the panel surface 55 above the return key 76 is touched by the object F, the second operation accepting unit 25 accepts the operation of the return key 76. This causes the display control unit 13 to switch the screen 73 displayed on the display unit 403 to the screen 68 illustrated in FIG. 12.

When the panel surface 55 above the portrait-oriented key 74 (or the landscape-oriented key 75) is touched by the object F, the second operation accepting unit 25 accepts the operation of the portrait-oriented key 74 (or the landscape-oriented key 75). When the operation of the portrait-oriented key 74 is accepted, the setting unit 27 accepts the setting to set the direction of the original document for portrait-oriented. When the operation of the landscape-oriented key 75 is accepted, the setting unit 27 accepts the setting to set the direction of the original document for landscape-oriented. When the operation of the portrait-oriented key 74 (or the landscape-oriented key 75) is accepted, the display control unit 13 switches the screen 73 displayed on the display unit 403 to the not illustrated next screen (a screen to select the order of aggregating, for example). Thereafter, in the same way as the operation of the touch operation mode described above, the setting of the multiple per sheet print is made.

Next, a description will be given of the performance of the non-touch operation mode as an exemplary setting of the multiple per sheet print. In a state where the screen 61, which is illustrated in FIG. 11, is displayed on the display unit 403, the overlap determining unit 19 uses the x coordinate, y coordinate, and z coordinate of the object position P to determine whether or not the object F, which is illustrated in FIGS. 5A and 5B and is within the predetermined distance from the screen 61, overlaps with the aggregate key 66 when viewing in the z-axis direction. That is, the overlap determining unit 19 determines whether or not the object F is located above the aggregate key 66.

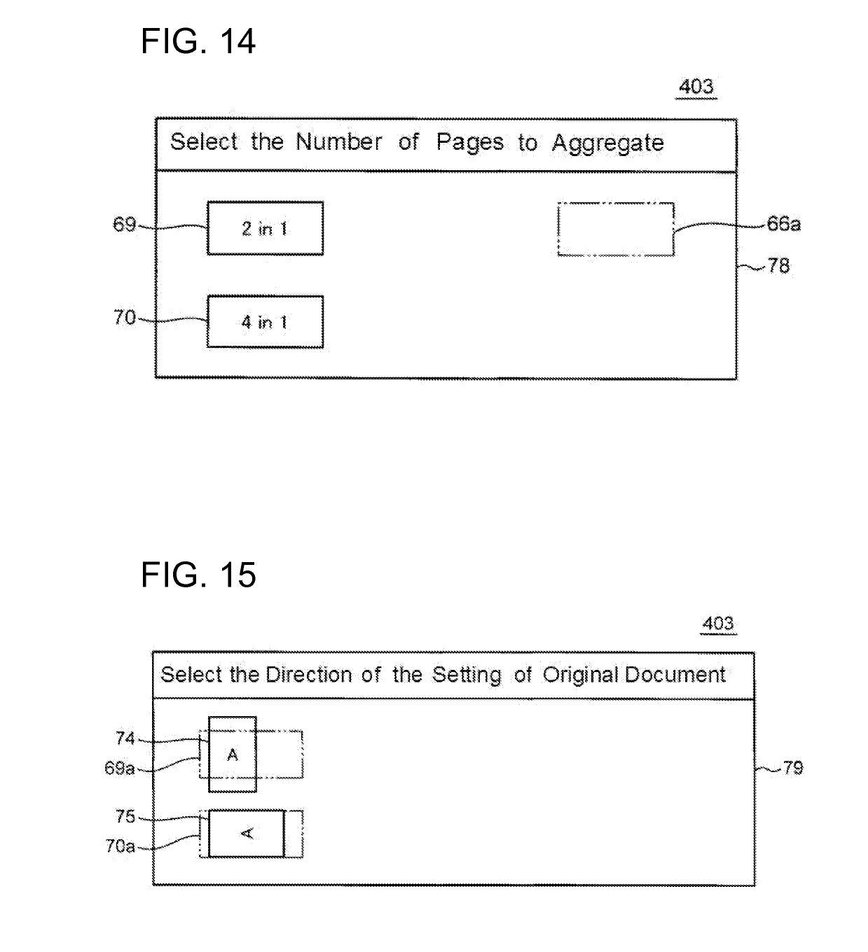

In a state where the object F is determined to be overlapping with the aggregate key 66 by the overlap determining unit 19, the first operation accepting unit 21 accepts the operation of the aggregate key 66, when the z coordinate of the object position P is determined to be changed into the direction where the object F approaches the aggregate key 66. That is, when the object F approaches the aggregate key 66, the operation of the aggregate key 66 is accepted. This causes the display control unit 13 to switch the screen 61 (the first the screen) displayed on the display unit 403 to a screen 78 (the second screen) illustrated in FIG. 14.

FIG. 14 illustrates the screen 78 for setting the number of pages of the original document to aggregate in one sheet at the setting of the multiple per sheet print in the non-touch operation mode. The screen 78 includes the 2-in-1 key 69 and the 4-in-1 key 70. The screen 78 is different from the screen 68 illustrated in FIG. 12 in that the screen 78 does not include the return key 71. Accordingly, a region indicated by reference numeral 66a is a virtual region that indicates the position on which the aggregate key 66 (see FIG. 11) were illustrated, and actually, the position 66a is not displayed on the screen 78.

Assume that after the screen is switched to the screen 78, the overlap determining unit 19 uses the x coordinate, y coordinate, and z coordinate of the object position P, which is measured by the coordinate measuring unit 15, to determine that the object F (illustrated in FIGS. 5A and 5B), which is within the predetermined distance from the screen 78, overlaps with the position 66a on which the aggregate key 66 is displayed when viewing in the z-axis direction, and the object F is brought away from the screen 78. In this case, the undo operation accepting unit 23 accepts the operation to return to the previous screen (the screen 61 in FIG. 11). That is, when the object F, which is above the position 66a on which the aggregate key 66 is displayed, is brought away from the screen 78 along the direction of the z-axis, the operation to return to the previous screen is accepted. This causes the display control unit 13 to switch the screen 78 displayed on the display unit 403 to the screen 61 illustrated in FIG. 11.

In a state where the screen 78 (illustrated in FIG. 14) is displayed on the display unit 403, the overlap determining unit 19 uses the x coordinate, y coordinate, and z coordinate of the object position P to determine whether or not the object F (illustrated in FIGS. 5A and 5B), which is within the predetermined distance from the screen 78, overlaps with the 2-in-1 key 69 (or the 4-in-1 key 70) when viewing in the z-axis direction. That is, the overlap determining unit 19 determines whether or not the object F is located above the 2-in-1 key 69 (or the 4-in-1 key 70).

In a state where the overlap determining unit 19 determines that the object F overlaps with the 2-in-1 key 69 (or the 4-in-1 key 70), the first operation accepting unit 21 accepts the operation of the 2-in-1 key 69 (or the 4-in-1 key 70), when the z coordinate of the object position P is determined to be changed into the direction where the object F approaches the 2-in-1 key 69 (or the 4-in-1 key 70). That is, when the object F approaches the 2-in-1 key 69 (or the 4-in-1 key 70), the operation of the 2-in-1 key 69 (or the 4-in-1 key 70) is accepted.

When the operation of the 2-in-1 key 69 is accepted, the setting unit 27 accepts the setting for 2-in-1. When the operation of the 4-in-1 key 70 is accepted, the setting unit 27 accepts the setting for 4-in-1. When the operation of the 2-in-1 key 69 (or the 4-in-1 key 70) is accepted, the display control unit 13 switches the screen 78 (the first screen) displayed on the display unit 403 to a screen 79 (the second screen) illustrated in FIG. 15.

Accordingly, without setting the number of pages to aggregate, that is, while the setting unit 27 does not accept the setting of the number of pages to aggregate, the screen 78 can be switched to the screen 79. In detail, in a state where the overlap determining unit 19 determines that the object F does not overlap with either of the 2-in-1 key 69 or the 4-in-1 key 70, the screen switch accepting unit 29 accepts to switch the screen, when the z coordinate of the object position P is determined to be changed into the direction where the object F approaches the screen 78. This causes the display control unit 13 to switch the screen 78 displayed on the display unit 403 to the screen 79. Therefore, without the operation of setting, switching to the next the screen (the second the screen) can be done.

FIG. 15 illustrates the screen 79 for setting the direction to set the original document at the setting of the multiple per sheet print in the non-touch operation mode. The screen 79 includes the portrait-oriented key 74 and the landscape-oriented key 75. The screen 79 is different from the screen 73 illustrated in FIG. 13 in that the screen 79 does not include the return key 76. Accordingly, a region indicated by reference numeral 69a is a virtual region that indicates the position on which the 2-in-1 key 69 (FIG. 14) were illustrated. A region indicated by reference numeral 70a is a virtual region that indicates the position on which the 4-in-1 key 70 (FIG. 14) were illustrated. Actually, the position 69a and the position 70a are not displayed on the screen 79.

Assume that after the screen is switched to the screen 79, the overlap determining unit 19 uses the x coordinate, y coordinate, and z coordinate of the object position P, which is measured by the coordinate measuring unit 15, to determine that the object F (illustrated in FIGS. 5A and 5B), which is within the predetermined distance from the screen 79, overlaps with the position 69a on which the 2-in-1 key 69 is displayed (or the position 70a on which the 4-in-1 key 70 is displayed) when viewing in the z-axis direction, and the object F is brought away from the screen 79. In this case, the undo operation accepting unit 23 accepts the operation to return to the previous screen (the screen 78 in FIG. 14). That is, when the object F, which is above the position 69a on which the 2-in-1 key 69 is displayed (or the position 70a on which the 4-in-1 key 70 is displayed), is brought away from the screen 79 along the direction of the z-axis, the operation to return to the previous screen is accepted. This causes the display control unit 13 to switch the screen 79 displayed on the display unit 403 to the screen 78 illustrated in FIG. 14.

In a state where the screen 79 illustrated in FIG. 15 is displayed on the display unit 403, the overlap determining unit 19 uses the x coordinate, y coordinate, and z coordinate of the object position P to determine whether or not the object F illustrated in FIGS. 5A and 5B, which is within the predetermined distance from the screen 79, overlaps with the portrait-oriented key 74 (or the landscape-oriented key 75) when viewing in the z-axis direction. That is, the overlap determining unit 19 determines whether or not the object F is located above the portrait-oriented key 74 (or the landscape-oriented key 75).

In a state where the overlap determining unit 19 determines that the object F overlaps with the portrait-oriented key 74 (or the landscape-oriented key 75), the first operation accepting unit 21 accepts the operation of the portrait-oriented key 74 (or the landscape-oriented key 75), when the z coordinate of the object position P is determined to be changed into the direction where the object F approaches the portrait-oriented key 74 (or the landscape-oriented key 75). That is, when the object F approaches the portrait-oriented key 74 (or the landscape-oriented key 75), the operation of the portrait-oriented key 74 (or the landscape-oriented key 75) is accepted.

When the operation of the portrait-oriented key 74 is accepted, the setting unit 27 accepts the setting to set the direction of the original document in portrait-oriented. When the operation of the landscape-oriented key 75 is accepted, the setting unit 27 accepts the setting to set the direction of the original document in the landscape-oriented. When the operation of the portrait-oriented key 74 (or the landscape-oriented key 75) is accepted, the display control unit 13 switches the screen 79 displayed on the display unit 403 to a not illustrated screen (for example, a screen to select the order of aggregating,). Thereafter, in the same way as the operation of the non-touch operation mode described above, the setting of the multiple per sheet print is made.

A description will be given of the main effect of the first embodiment. As described in the description of the non-touch operation mode, in the operation display device 3 according to the first embodiment, in a state where the object F illustrated in FIGS. 5A and 5B, which is within the predetermined distance from a screen (for example, the screen 61 illustrated in FIG. 11), is determined to overlap with a software key (for example, the aggregate key 66) when viewing in the z-axis direction, when the z coordinate of the object position P is determined to be changed, the operation display device 3 accepts the operation of the software key, and switches the screen to display on the display unit 403 (for example, the screen 78 illustrated in FIG. 14). Therefore, the operation display device 3 according to the first embodiment can operate the software key and switch the screen without touching the display unit 403. This can improve the operability when there are many setting screens in setting the function.

Alternatively, in the operation display device 3 according to the first embodiment, after a screen is switched to the second screen (for example, the screen 78 illustrated in FIG. 14), when the object F, which is within the predetermined distance from the second screen, is determined to overlap with a position on which a software key is displayed (for example, the position 66a illustrated in FIG. 14) when viewing in the z-axis direction, and determined to be brought away from the second screen, the operation display device 3 switches the second screen to the first screen (for example, the screen 61 illustrated in FIG. 11). Therefore, the operation display device 3 according to the first embodiment can return the screen to the previous screen without touching the display unit 403.

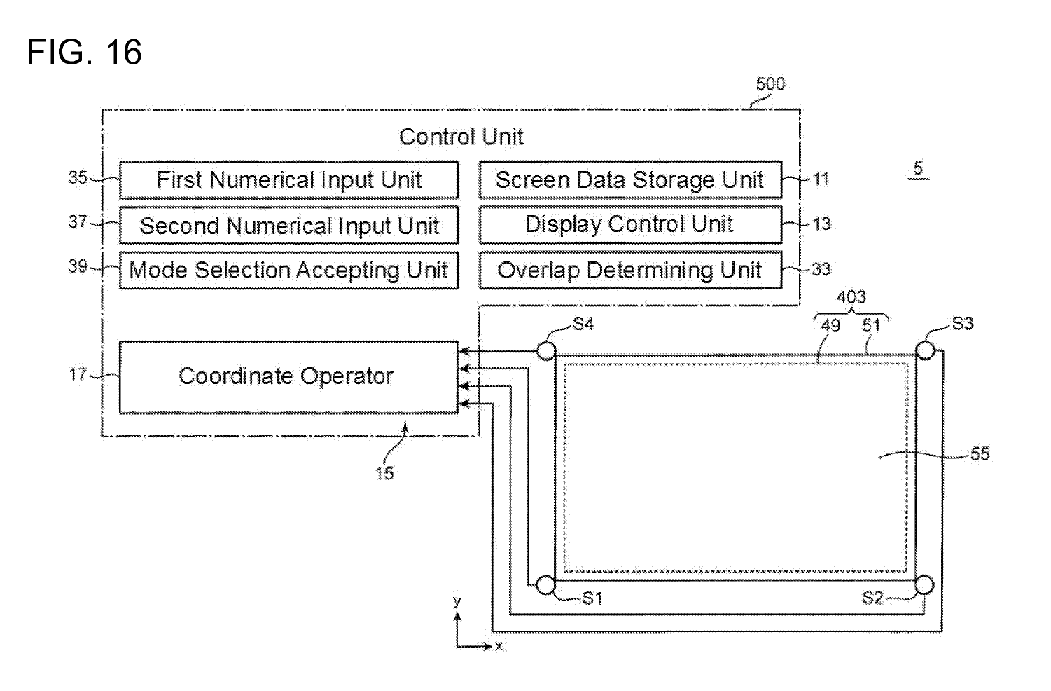

Next, a description will be given of an operation display device 5 according to the second embodiment, mainly the difference from the operation display device 3 according to the first embodiment. FIG. 16 illustrates a configuration of the operation display device 5 according to the second embodiment. The operation display device 5 includes an overlap determining unit 33, a first numerical input unit 35, a second numerical input unit 37, and a mode selection accepting unit 39, instead of the units included in the operation display device 3 illustrated in FIG. 3, such as the overlap determining unit 19, the first operation accepting unit 21, the undo operation accepting unit 23, the second operation accepting unit 25, the setting unit 27, the screen switch accepting unit 29, and the mode selection accepting unit 31.

The overlap determining unit 33 uses the x coordinate, y coordinate, and z coordinate of the object position P to determine whether or not the object F illustrated in FIGS. 5A and 5B, which is in the predetermined distance from the screen displayed on the display unit 403, overlaps with the predetermined region on the screen when viewing in the z-axis direction (the direction normal to the screen).

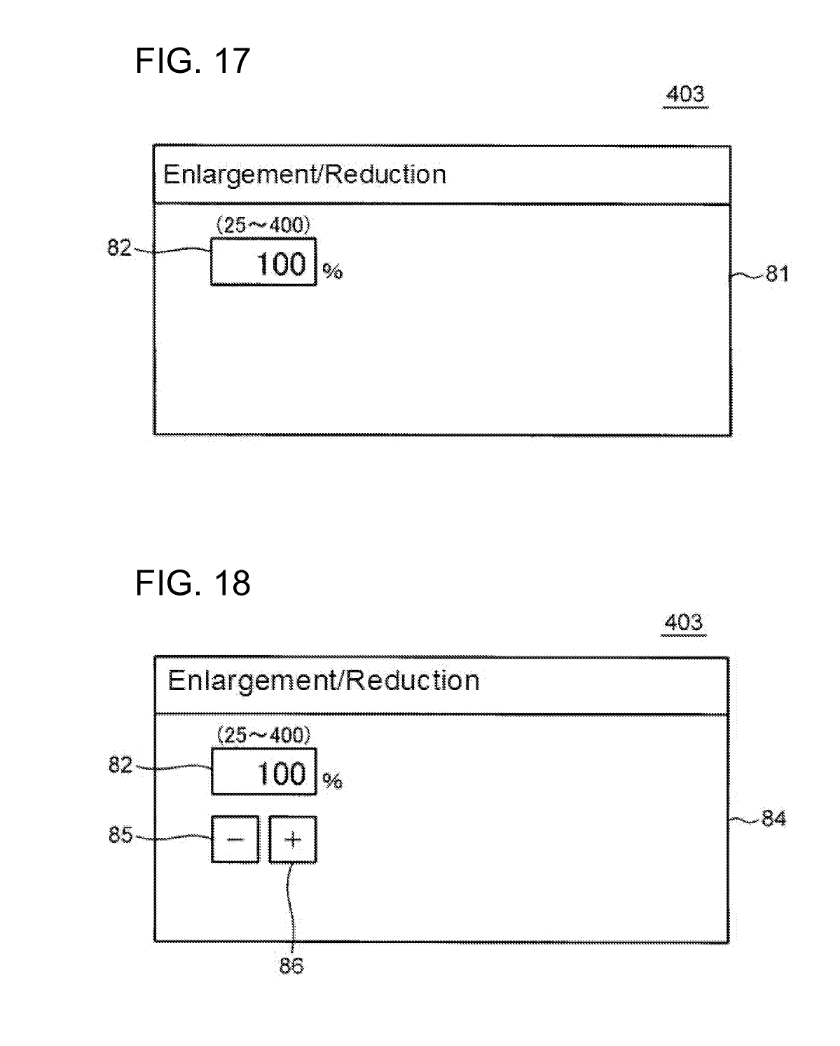

A description will be given of the predetermined region. FIG. 17 illustrates a screen 81 for setting the enlargement/reduction of the copying image in the non-touch operation mode. A numerical value display region 82 displays values of enlargement/reduction magnification. The numerical value display region 82 is an example of the predetermined region.

When the x coordinate of the object F is included in a range of the x coordinate of the predetermined region, the y coordinate of the object F is included in a range of the y coordinate of the predetermined region, and the z coordinate of the object F is not included in a range of the z coordinate of the predetermined region, the object F can be determined to be overlapping with the predetermined region when viewing in the z-axis direction.

The state where the object F overlaps with the predetermined region when viewing in the z-axis direction is, in other words, the state where the object F three-dimensionally overlaps with the predetermined region, or the state where the object F is positioned above the predetermined region.

In a state where the overlap determining unit 33 determines that the object F overlaps with the predetermined region, the first numerical input unit 35 accepts to input the different numerical value corresponding to the change of the z coordinate.

The first numerical input unit 35 has two aspects. In the first aspect, in a state where the overlap determining unit 33 determines that the object F overlaps with the predetermined region, the first aspect accepts to input the numerical value that decreases as the object F approaches the predetermined region and increases as the object F is brought away from the predetermined region. In the second aspect, in a state where the overlap determining unit 33 determines that the object F overlaps with the predetermined region, the second aspect accepts to input the numerical value that increases as the object F approaches the predetermined region and decreases as the object F is brought away from the predetermined region. In this embodiment, a description will be given of the first aspect.

The display control unit 13 causes the numerical value display region 82 to display the numerical value accepted by the first numerical input unit 35.

When the overlap determining unit 33 determines that the z coordinate of the object position P illustrated in FIGS. 5A and 5B does not change, and the object F has changed from the state overlapping with the predetermined region to the state not overlapping with the predetermined region, the first numerical input unit 35 determines a numerical value displayed on the numerical value display region 82 as a numerical value to be input, and terminates the accepting of the numerical value input.

In a state where the display unit 403 (the display panel portion 49) displays the screen including a software key to input the numerical value, the second numerical input unit 37 accepts the input of the numerical value to display on the numerical value display region 82, by the operation to the software key that the object F illustrated in FIGS. 5A and 5B touches the panel surface 55 above the software key.

A description will be given of the software key to input the numerical value. FIG. 18 illustrates a screen 84 for setting the enlargement/reduction of the copying image in the touch operation mode. The screen 84 is different from the screen 81 illustrated in FIG. 17 in that the screen 84 includes a negative key 85 and a positive key 86. When the panel surface 55 above the negative key 85 is touched by the object F illustrated in FIGS. 5A and 5B, the numerical value displayed on the numerical value display region 82 decreases. When the panel surface 55 above the positive key 86 is touched by the object F, the numerical value displayed on the numerical value display region 82 increases. The negative key 85 and the positive key 86 are the examples of the software key for the numerical value input.

The mode selection accepting unit 39, similarly to the mode selection accepting unit 31 illustrated in FIG. 3, selects the touch operation mode when the user selects the touch operation mode by operating the operation unit 400, and selects the non-touch operation mode when the user selects the non-touch operation mode by operating the operation unit 400.

The touch operation mode is a mode that uses the display panel portion 49, the touch panel portion 51, the display control unit 13, and the second numerical input unit 37 to execute the input of the numerical value to display on the numerical value display region 82. The touch operation mode is an operation mode that is similar to the ordinary touch panel apparatus, and the operation mode that is operated by touching the panel surface 55.

The non-touch operation mode is a mode that uses the display panel portion 49, the display control unit 13, the coordinate measuring unit 15, the overlap determining unit 33, and the first numerical input unit 35 to execute the input of the numerical value to display on the numerical value display region 82. The non-touch operation mode is a mode that operates without touching the panel surface 55.

The performance of the operation display device 5 according to the second embodiment will be described with reference to FIGS. 5A and 5B, FIG. 11, FIG. 16, FIG. 17, and FIG. 18. The performance of the operation display device 5 includes the performance of the touch operation mode and the performance of the non-touch operation mode. First, a description will be given of the performance of the touch operation mode as an example of the numerical value input of the copying image enlargement/reduction.

The display control unit 13 controls to display the screen 61 illustrated in FIG. 11 on the display unit 403. When the panel surface 55, which is above the enlargement/reduction key 63 included in the screen 61, is touched by the object F illustrated in FIGS. 5A and 5B, the operation of the enlargement/reduction key 63 is accepted. This causes the display control unit 13 to switch the screen 61 displayed on the display unit 403 to the screen 84 illustrated in FIG. 18.

When the panel surface 55 above the negative key 85 is touched by the object F, the second numerical input unit 37 accepts the numerical value input that decreases from “100” in increments of one. When the panel surface 55 above the positive key 86 is touched by the object F, the second numerical input unit 37 accepts the numerical value input that increases from “100” in increments of one.

The display control unit 13 causes the numerical value display region 82 to display the numerical value that is input into the second numerical input unit 37.

Next, a description will be given of the performance of the non-touch operation mode as an exemplary numerical value input of the copying image enlargement/reduction. In a state where the screen 61 illustrated in FIG. 11 is displayed on the display unit 403, the overlap determining unit 33 uses the x coordinate, y coordinate, and z coordinate of the object position P to determine whether or not the object F illustrated in FIGS. 5A and 5B, which is within the predetermined distance from the screen 61, overlaps with the enlargement/reduction key 63 when viewing in the z-axis direction. That is, the overlap determining unit 33 determines whether or not the object F is located above the enlargement/reduction key 63.

In a state where, the overlap determining unit 33 determines that the object F overlaps with the enlargement/reduction key 63, the first numerical input unit 35 accepts the operation of the enlargement/reduction key 63 when the z coordinate of the object position P is determined to be changed into the direction where the object F approaches the enlargement/reduction key 63. That is, when the object F approaches the enlargement/reduction key 63, the operation of the enlargement/reduction key 63 is accepted. This causes the display control unit 13 to switch the screen 61 displayed on the display unit 403 to the screen 81 illustrated in FIG. 17.

In a state where the overlap determining unit 33 determines that the object F illustrated in FIGS. 5A and 5B overlaps with the numerical value display region 82 (predetermined region), the first numerical input unit 35 accepts the input of the decreasing numerical value corresponding to the change of the z coordinate of the object position P by bringing the object F close to the numerical value display region 82. That is, bringing the object F close to the numerical value display region 82 decreases gradually the numerical value to be input as “99,” “98,” “97,” and so on.

In a state where the overlap determining unit 33 determines that the object F overlaps with the numerical value display region 82, the first numerical input unit 35 accepts the input of the increasing numerical value corresponding to the change of the z coordinate of the object position P by bringing the object F away from the numerical value display region 82. That is, bringing the object F away from the numerical value display region 82 increases gradually the numerical value to be input as “101,” “102,” “103,” and so on.

The display control unit 13 causes the numerical value display region 82 to display the numerical value that is input in the first numerical input unit 35.

Thus, in the operation display device 5 according to the second embodiment, in a state where the object F illustrated in FIGS. 5A and 5B, which is within a predetermined distance from the screen 81 illustrated in FIG. 17, is determined to overlap with the numerical value display region 82 on the screen 81 (predetermined region) when viewing in the z-axis direction, the operation display device 5 accepts the input of the different numerical value corresponding to the change of the z coordinate of the object position P, and causes the numerical value display region 82 to display the numerical value . Therefore, the operation display device 5 according to the second embodiment can operate to input the numerical value without touching the display unit 403 is possible. This can improve the operability in inputting the numerical value.

Accordingly, the operation display device 5 according to the second embodiment sets the numerical value display region 82 as a predetermined region. Therefore, software keys to input the numerical value (for example, the negative key 85 and the positive key 86 illustrated in FIG. 18) does not need to be included on the screen 81.

When the overlap determining unit 33 determines that the z coordinate of the object position P illustrated in FIGS. 5A and 5B does not change, and the object F changed from the state overlapping with the numerical value display region 82 to the state not overlapping with the numerical value display region 82, the first numerical input unit 35 determines a numerical value displayed on the numerical value display region 82 as a numerical value to be input, and terminates the accepting of the numerical value input. That is, when the object F moves in the lateral direction, the first numerical input unit 35 terminates the operation to input the numerical value and determines the numerical value to be input.

Therefore, in the operation display device 5 according to the second embodiment, moving the object F, which is within the predetermined distance from the screen 81, to the lateral direction determines the numerical value to input. Then, it is possible to determine the numerical value to input without touching the display unit 403.

As described above, according to the first embodiment and the second embodiment, the operation that is similar to the operation of the touch panel apparatus is possible without touching the display unit 403. Accordingly, the embodiments are effective in the following cases.
(1) The hand and the finger are greasy or similar conditions.
(2) The screen cannot be touched smoothly because of the narrow range of motion by the handicapped hand and finger.
(3) The portion of the glove where the finger is put in is larger than the finger, and the portion deforms in touching a software key to cause a touch of the next software key by error.

A description will be given of a modification of the first embodiment and the second embodiment. The first embodiment and the second embodiment have the coordinate measuring unit 15 as illustrated in FIG. 3 and FIG. 16. The modification of the first embodiment and the second embodiment uses the touch panel portion 51 having the function of the coordinate measuring unit 15. That is, the touch panel portion 51 includes the panel surface 55 to be touched by the object F. The touch panel portion 51 is a touch panel employing a capacitive touchscreen method. The touch panel portion 51 has a first function to detect the position on which the panel surface 55 is touched and the second function to measure the x coordinate, y coordinate, and z coordinate of the object position P. The modification of the first embodiment and the second embodiment uses the touch panel portion 51 that can detect the x coordinate and the y coordinate on the panel surface 55 and, in addition, the z coordinate that is vertical to the panel surface 55. The touch panel such as the touch panel portion 51 is publicly known to achieve by a capacitive touchscreen method.

In the modification of the first embodiment, with reference to FIG. 3, the touch operation mode uses the display panel portion 49, the first function of the touch panel portion 51, the display control unit 13, the second operation accepting unit 25, and the setting unit 27 to execute operations. The non-touch operation mode uses the display panel portion 49, the second function of the touch panel portion 51, the display control unit 13, the overlap determining unit 19, the first operation accepting unit 21, the undo operation accepting unit 23, the setting unit 27, and the screen switch accepting unit 29 to execute operations.

In the modification of the second embodiment, with reference to FIG. 16, the touch operation mode uses the display panel portion 49, the first function of the touch panel portion 51, the display control unit 13, and the second numerical input unit 37 to execute operations. The non-touch operation mode uses the display panel portion 49, the second function of the touch panel portion 51, the display control unit 13, the overlap determining unit 33, and the first numerical input unit 35 to execute operations.

According to the modification of the first embodiment and the second embodiment, the touch panel portion 51 has the function of the coordinate measuring unit 15 (the second function). Then, another coordinate measuring unit 15 does not need to be disposed to execute the non-touch operation mode.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An operation display device, comprising:
a display unit;
a display control unit that causes the display unit to display a screen;
a coordinate measuring unit that measures a coordinate of a first direction, a coordinate of a second direction, and a coordinate of a third direction indicative of a position of an object corresponding to a position of the object within a predetermined distance from the screen, the first direction and the second direction being directions to specify a plane of coordinates on the screen, the third direction being a direction vertical to the screen;
an overlap determining unit that determines whether the object within the predetermined distance from a first screen overlaps a software key viewed from the third direction or not using the coordinate of the first direction, the coordinate of the second direction, and the coordinate of the third direction in a state where the first screen is displayed on the display unit, the first screen being the screen including the software key; and
a first operation accepting unit that accepts an operation of the software key when the first operation accepting unit determines that the coordinate of the third direction has changed in a state where the overlap determining unit determines that the object overlaps the software key; wherein
when the first operation accepting unit accepts the operation of the software key, the display control unit switches the screen displayed by the display unit from the first screen to a second screen, the second screen being the screen different from the first screen.

2. The operation display device according to claim 1, wherein:
in a state where the overlap determining unit determines that the object overlaps the software key, the first operation accepting unit determines whether the object approaches the software key or not from a change in the coordinate of the third direction; and
when the first operation accepting unit determines the object approaches the software key, the first operation accepting unit accepts the operation of the software key.

3. The operation display device according to claim 2, further comprising:
an undo operation accepting unit that accepts an operation to return to a previous screen when the object within the predetermined distance from the second screen is determined to overlap a position where the software key is displayed on the first screen viewed from the third direction and is brought away from the second screen after switched to the second screen using the coordinate of the first direction, the coordinate of the second direction, and the coordinate of the third direction measured by the coordinate measuring unit; wherein
when the undo operation accepting unit accepts an operation to return to a previous screen, the display control unit switches the screen displayed by the display unit from the second screen to the first screen.

4. The operation display device according to claim 1, wherein:
the software key includes a plurality of software keys, predetermined settings being assigned to the respective plurality of software keys;
the operation display device further comprises
a setting unit that accepts a setting assigned to the software key whose operation is accepted when the first operation accepting unit accepts any of operations of the plurality of the software keys, and
a screen switch accepting unit that accepts switching of the screens when the screen switch accepting unit determines that the coordinate of the third direction changes while the overlap determining unit determines that the object does not overlap any of the plurality of software keys; and
when the screen switch accepting unit accepts the switching of the screens, the display control unit switches the screen displayed by the display unit from the first screen to the second screen.

5. The operation display device according to claim 1, wherein:
the coordinate measuring unit has a panel surface where the object is to be touched, the coordinate measuring unit being a touch panel unit using an electrostatic capacity method having a first function and a second function, the first function detecting a position of the panel surface being touched, the second function measuring the coordinate of the first direction, the coordinate of the second direction, and the coordinate of the third direction;
the display unit includes a display panel unit and the touch panel unit, the display panel unit displaying the screen, the touch panel unit being arranged on the display panel unit;
the operation display device includes
a second operation accepting unit that accepts the operation of the software key when the object touches the panel surface on the software key in a state where the display panel unit displays the first screen, and
a mode selection accepting unit that accepts selection of a touch operation mode and a non-touch operation mode;
the touch operation mode performs acceptance of the operation of the software key and switching from the first screen to the second screen using the display panel unit, the first function of the touch panel unit, the display control unit, and the second operation accepting unit; and
the non-touch operation mode performs the acceptance of the operation of the software key and the switching from the first screen to the second screen using the display panel unit, the second function of the touch panel unit, the display control unit, the overlap determining unit, and the first operation accepting unit.

6. An operation display device, comprising:
a display unit;
a display control unit that causes the display unit to display a screen including a numerical value display region;
a coordinate measuring unit that measures a coordinate of a first direction, a coordinate of a second direction, and a coordinate of a third direction indicative of a position of an object corresponding to a position of the object within a predetermined distance from the screen, the first direction and the second direction being directions to specify a plane of coordinates on the screen, the third direction being a direction vertical to the screen;
an overlap determining unit that determines whether the object within the predetermined distance from the screen overlaps a predetermined region of the screen viewed from the third direction or not using the coordinate of the first direction, the coordinate of the second direction, and the coordinate of the third direction; and
a first numerical input unit that accepts an input of values of different magnitudes according to the coordinate of the third direction in a state where the overlap determining unit determines that the object overlaps the predetermined region; wherein
the display control unit causes a value accepted by the first numerical input unit to be displayed at the numerical value display region.

7. The operation display device according to claim 6, wherein:
in a state where the overlap determining unit determines that the object overlaps the predetermined region, the first numerical input unit (1) accepts an input of a value decreased as the object is brought close to the predetermined region, and accepts an input of a value increased as the object is brought away from the predetermined region, or (2) accepts an input of a value increased as the object is brought close to the predetermined region, and accepts an input of a value decreased as the object is brought away from the predetermined region.

8. The operation display device according to claim 6, wherein:
when the overlap determining unit determines that the coordinate of the third direction does not change and the object changes from a state of overlapping the predetermined region to a state of not overlapping the predetermined region, the first numerical input unit fixes a value displayed at the numerical value display region as an input value and terminates acceptance of an input of a value.

9. The operation display device according to claim 6, wherein the predetermined region is the numerical value display region.

10. The operation display device according to claim 6, wherein:
the coordinate measuring unit has a panel surface where the object is to be touched, the coordinate measuring unit being a touch panel unit using an electrostatic capacity method having a first function and a second function, the first function detecting a position of the panel surface being touched, the second function measuring the coordinate of the first direction, the coordinate of the second direction, and the coordinate of the third direction;
the display unit includes a display panel unit and the touch panel unit, the display panel unit displaying the screen, the touch panel unit being arranged on the display panel unit;
the operation display device includes
a second numerical input unit that accepts an input of a value displayed at the numerical value display region when the object touches the panel surface on the software key to operate the software key in a state where the display panel unit displays the screen including a software key for numerical input, and
a mode selection accepting unit that accepts selection of a touch operation mode and a non-touch operation mode;
the touch operation mode inputs a value displayed at the numerical value display region using the display panel unit, the first function of the touch panel unit, the display control unit, and the second numerical input unit; and
the non-touch operation mode inputs a value displayed at the numerical value display region using the display panel unit, the second function of the touch panel unit, the display control unit, the overlap determining unit, and the first numerical input unit.

11. An operation display method, comprising:
causing a display unit to display a screen;
measuring a coordinate of a first direction, a coordinate of a second direction, and a coordinate of a third direction indicative of a position of an object corresponding to a position of the object within a predetermined distance from the screen, the first direction and the second direction being directions to specify a plane of coordinates on the screen, the third direction being a direction vertical to the screen;
determining whether the object within the predetermined distance from a first screen overlaps a software key viewed from the third direction or not using the coordinate of the first direction, the coordinate of the second direction, and the coordinate of the third direction in a state where the first screen is displayed on the display unit, the first screen being the screen including the software key; and
accepting an operation of the software key when the first operation accepting unit determines that the coordinate of the third direction has changed in a state where the overlap determining unit determines that the object overlaps the software key; wherein
when the accepting includes accepting the operation of the software key, the display control unit switches the screen displayed by the display unit from the first screen to a second screen, the second screen being the screen different from the first screen.
